(19) United States
(12) Patent Application Publication
(10) Pub. No.: US 2007/0218927 A1
(43) Pub. Date: Sep. 20, 2007

(54) Method and related apparatus for handling point-to-multipoint MBMS service in a wireless communications system

(75) Inventor: Richard Lee-Chee Kuo, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/716,632

(22) Filed: Mar. 12, 2007

Related U.S. Application Data
(60) Provisional application No. 60/743,480, filed on Mar. 14, 2006.

(51) Int. Cl. H04Q 7/20

(52) U.S. Cl. 455/466

(57) ABSTRACT

A method of handling a point-to-multipoint MBMS service for a receiver in a wireless communication system including: detecting whether a cell provide the point-to-multipoint MBMS service when the receiver moves into a new cell; and releasing resources of the receiver used for receiving the point-to-multipoint MBMS service if the cell provides no point-to-multipoint MBMS service.

### CROSS REFERENCE TO RELATED APPLICATIONS

This application claims the benefit of U.S. Provisional Application No. 60/743,480, filed on Mar. 14, 2006 and entitled “Method and Apparatus to handle the situation when the UE moves into a new cell not supporting the p-t-m MBMS Services in a Wireless Communications System”, the contents of which are incorporated herein by reference.

### BACKGROUND OF THE INVENTION

1. Field of the Invention

The present invention relates to a method and related device for handling point-to-multipoint MBMS service, and more particularly, to a method and related device for handling an MBMS service for a receiving terminal in a wireless communications system to save system resources and power of the receiving terminal.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. To enhance multimedia functions in the 3G mobile telecommunications system, a protocol specification developed by the 3^{rd} Generation Partnership Project (3GPP) provides Multimedia Broadcast Multicast Service (MBMS). MBMS is a point-to-multipoint bearer service and is established on an existing network architecture of the Universal Mobile Telecommunications System (UMTS), utilizing Internet Protocol (IP) packets as a medium. Thus, MBMS allows a single source entity to transmit data to multiple user entities simultaneously.

Since the 3GPP has thoroughly defined operations and architecture of MBMS in the related specifications, the operations and architecture of MBMS are described only briefly hereinafter. For the universal mobile telecommunications system (UMTS), the 3G communications system comprises User Equipment (UE), the UMTS Terrestrial Radio Access Network (UTRAN), and the Core Network (CN). Communications protocols utilized include Access Stratum (AS) and Non-Access Stratum (NAS). AS comprises various sub-layers for different functions, including Radio Resource Control (RRC), Radio Link Control (RLC), Media Access Control (MAC), Packet Data Convergence Protocol (PDCP), and Broadcast/Multicast Control (BMC). The sub-layers mentioned, and their operating principles, are well known in the art, and detailed description thereof is omitted. For MBMS, the Core Network further comprises the Broadcast Multicast Service Center (BM-SC) that is not only a newly added network node but also an entry point for receiving external data, e.g. data provided by a content provider. The BM-SC manages provision, delivery, announcement, authorization, and storage of related parameters for MBMS services, and transmits corresponding information to the Gateway GPRS Support Node (GGSN). In the MBMS system architecture, the GGSN plays a role as an entry point for IP multicast traffic, and routes MBMS data to the Serving GPRS Support Node (SGSN) via a proper GPRS Tunnel (GTP). More than one SGSN can exist under the GGSN. The SGSN performs MBMS Bearer Service control functions to accurately transmit data packets to the UTRAN, allowing multiple UEs, which order the same MBMS service in the same UTRAN to receive the same MBMS data. The SGSN can comprise more than one Radio Network Controller (RNC). The RNCs are responsible for efficiently allocating radio resources for the UEs according to the number of UEs counted by the Node-Bs (NB). The RNC comprises more than one NB that is responsible for transmitting or receiving radio waves to or from the UEs.

According to the protocol specification developed by the 3GPP, MBMS offers two service modes: Broadcast mode and Multicast mode. When interested in a specific MBMS service, the UE needs to order the BM-SC for the MBMS service by establishing a service agreement including specific service provision phases. These two service modes have different service provision phases. The service provision phase of Broadcast mode includes Service announcement, Session Start, MBMS notification, Data Transfer and Session Stop. The service provision phase of Multicast mode includes Subscription, Service announcement, Joining, Session Start, MBMS notification, Data Transfer, Session Stop and Leaving. For realizing customized services, Joining and Leaving sessions utilized in Multicast mode enable the BM-SC to execute authorization and payment recording for the UEs at the Joining session. The service provision phases mentioned above are well known in the art, and will not be described in detail.

From the standpoint of the RRC, all logical data communication exchange channels, be they for providing data transmission exchange to the UE or for providing RRC layer control signal transmission exchange, are defined in the context of a Radio Bearer (RB). In the UE end, the RB comprises one unidirectional, or a pair of, uplink/downlink logic data transmission exchange channels. In the network end, the RB comprises one unidirectional, or a pair of, uplink/downlink logic data transmission exchange channels.

When providing the MBMS service, the UTRAN may count the number of the UEs ordering the MBMS service via a counting procedure, and adopt either one of the following two transmission modes: point-to-point (p-t-p) transmission and point-to-multipoint (p-t-m) transmission. In the p-t-p transmission, transmission between the UEs and the UTRAN utilizes a dedicated-channel, and thereby the Node-B establishes one dedicated channel for one UE to transmit data and configuration. Compared with the p-t-p transmission, the p-t-m transmission allows the CN to provide the data and the configuration for multiple UEs in the same cell simultaneously. In addition, when the MBMS service is in Broadcast mode, only the p-t-m transmission is used. When the MBMS service is in Multicast mode, the UTRAN switches between the p-t-p and p-t-m transmissions according to the number of UEs. In the protocol specification developed by the 3GPP, three logical channels are defined to transmit corresponding MBMS information: MBMS point-to-multipoint Control Channel (MCCH), MBMS point-to-multipoint Traffic Channel (MTCH), and MBMS point-to-multipoint Scheduling Channel (MSCH). The three logical channels are mapped onto a transport channel, Forward Access Channel (FACH), and the FACH is mapped onto a physical channel, Secondary Common Control Physical Channel (S-CCPCH). MCCH is utilized to transmit a corresponding MBMS configuration, including MBMS Radio Bearer Information, MBMS Service Information, and other information. In general, before obtaining the MBMS configuration, the UE first has to receive System Information block type 5 or 5bis through S-CCPCH, and detect whether MCCH configuration carrying the above-mentioned information is included in the System Information block type 5 or 5bis.

Thus, when a UE is interested in an MBMS service, the UE establishes the service agreement with the BM/SC. If a Broadcast service is selected by multiple UEs in the same cell, the UTRAN establishes a p-t-m radio bearer(s) with the multiple UEs at Session Start. Oppositely, if a Multicast service is selected, the UTRAN performs a counting procedure to obtain the number of UEs at Session Start, and thereby utilizes the p-t-m transmission under the condition that the number of UEs exceeds a specific value, or else utilizes the p-t-p transmission. Under the p-t-m transmission, the UTRAN creates a p-t-m radio bearer(s) with the multiple UEs ordering the Multicast service so as to transfer service data. After the UEs begin to enjoy the show they ordered, the UEs operate in Data Transfer session, and the UEs receive corresponding control information, such as MCCH configuration, through S-CCPCH periodically, so as to obtain real-time status of the service.

While receiving the MBMS service, since the UE may not be static but moving, such as walking or driving, the UE may leave a cell and enter a new cell. If the new cell does not support MBMS services, then MCCH may not exist in the cell. However, the prior art does not specify the UE behavior to handle the situation when a UE entering a new cell which does not support MBMS services. The UE may keep trying to receive the MBMS service using the previous MTCH configuration even though no MBMS service is transmitted by the cell. As a result, the UE wastes power and system resources on reception of the MBMS service.

### SUMMARY OF THE INVENTION

It is therefore a primary object of the present invention to provide a method of handling a point-to-multipoint multimedia broadcast multicast service (MBMS) service in a wireless communications system and related device.

The present invention discloses a method of handling a point-to-multipoint Multimedia Broadcast Multicast Service (MBMS) service for a receiving terminal in a wireless communications system. The method includes the following steps: detecting whether a cell provides the MBMS service when the receiving terminal moves into a new cell, and releasing a resource used by the receiving terminal for receiving the MBMS service if the cell does not provide the MBMS service.

The present invention further discloses a receiving device for correctly handling a point-to-multipoint Multimedia Broadcast Multicast Service (MBMS) service in a wireless communications system. The receiving device includes a control circuit, a processor and a memory. The control circuit is used for realizing functions of the receiving device. The processor is installed inside the control circuit and is used for executing a program code to command the control circuit. The memory is coupled to the processor and is used for storing the program code. The program code comprises detecting whether a cell provides the MBMS service when the receiving Device moves into a new cell; and releasing a resource used by the receiving device for receiving the MBMS service if the cell does not provide the MBMS service.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a receiving device.

FIG. 2 is a diagram of program code in FIG. 1.

FIG. 3 is a flow chart of a method according to the present invention.

FIG. 4 is a schematic diagram of a network framework for handling a MBMS service in the 3G mobile telecommunications system according to an embodiment of the present invention.

### DETAILED DESCRIPTION

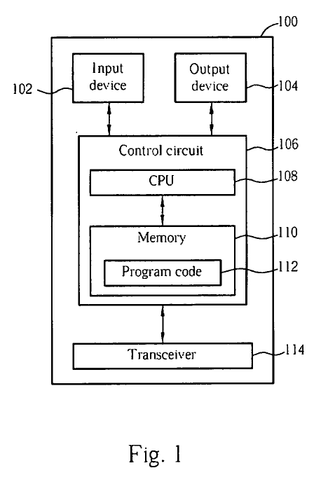

Please refer to FIG. 1, which is a functional block diagram of a receiving device 100. For the sake of brevity, FIG. 1 only shows an input device 102, an output device 104, a control circuit 106, a central processing unit (CPU) 108, a memory 110, a program code 112, and a transceiver 114 of the receiving device 100. In the receiving device 100, the control circuit 106 executes the program code 112 in the memory 110 through the CPU 108, thereby controlling an operation of the receiving device 100. The receiving device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

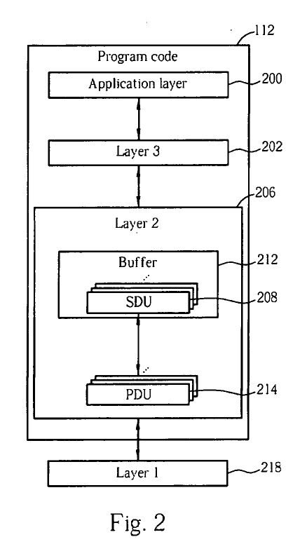

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. When signals are transmitted, the Layer 2 206 generates multiple serving data units (SDUs) 208 in a buffer 212 based on the data output by the Layer 3 202. The Layer 2 206 generates multiple protocol data units (PDUs) 214 according to the SDUs 208 and further outputs the PDUs 214 to Layer 1 218 for transmission. On the contrary, when wireless signals are received, the Layer 1 218 is used for receiving the wireless signals, and the received wireless signals are outputted in a format of the PDUs 214 to the Layer 2 206. The Layer 2 206 recovers the PDUs 214 to the SDUs 208 stored in the buffer 212. Finally, the Layer 2 206 transfers the SDUs 208 to the Layer 3 202.

Preferably, the receiving device 100 is adopted in the 3G mobile telecommunications system, and used for receiving point-to-multipoint (p-t-m) Multimedia Broadcast Multicast Service (MBMS) services. The present invention configures corresponding algorithms in the program code 112 to handle the p-t-m MBMS service to prevent a waste of system resources and power consumption.

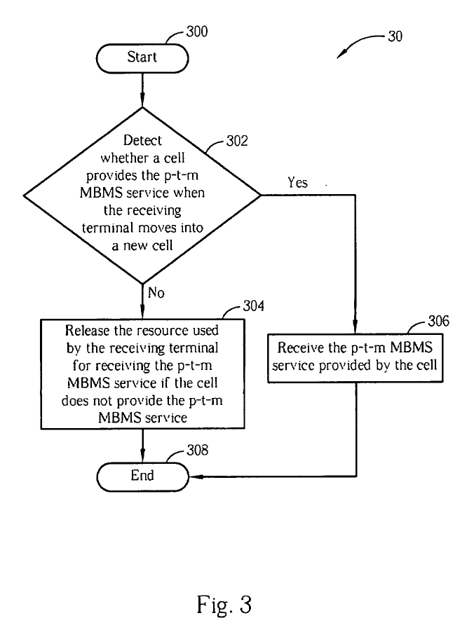

Please refer to FIG. 3, which is a flowchart of a process 30 according to an embodiment of the present invention. The process 30 is adopted to handle a p-t-m Multimedia Broadcast Multicast Service (MBMS) service in a receiving terminal of the wireless communications system. The process 30 includes the following steps:
Step 300: Start.
Step 302: Detect whether a cell provides the p-t-m MBMS service when the receiving terminal moves into a new cell. If so, go to Step 306; if not, go to Step 304.
Step 304: Release a resource used by the receiving terminal for receiving the p-t-m MBMS service if the cell does not provide the p-t-m MBMS service, and then go to Step 308.
Step 306: Receive the p-t-m MBMS service provided by the cell.
Step 308: End.

According to the process 30, when the receiving terminal uses the p-t-m MBMS resource, the receiving terminal begins to detect whether the cell provides the p-t-m MBMS service when moving into coverage of a new cell. If so, the receiving terminal receives the p-t-m MBMS service provided by the cell. Otherwise, the receiving terminal immediately releases the p-t-m MBMS resource in use. In the 3G mobile telecommunications system, the resource used by the receiving terminal for receiving the p-t-m MBMS service is/are commonly a radio bearer(s). MCCH is utilized to transmit a corresponding MBMS configuration, including MBMS Radio Bearer Information, MBMS Service Information, and other information. Before obtaining the MBMS configuration from the cell, the UE first has to receive System Information block type 5 or 5bis through S-CCPCH, and detect whether MCCH configuration carrying the above-mentioned information is included in the System Information block type 5 or 5bis. Thus, if the receiving terminal finds that the System Information block type 5 or 5bis does not include any MBMS point-to-multipoint Control Channel (MCCH) configuration information, the receiving terminal determines that the cell does not provide the p-t-m MBMS service. Under this circumstance, the receiving terminal releases the radio bearer(s) so as to stop reception of the p-t-m MBMS service to prevent the waste of system resources and power consumption.

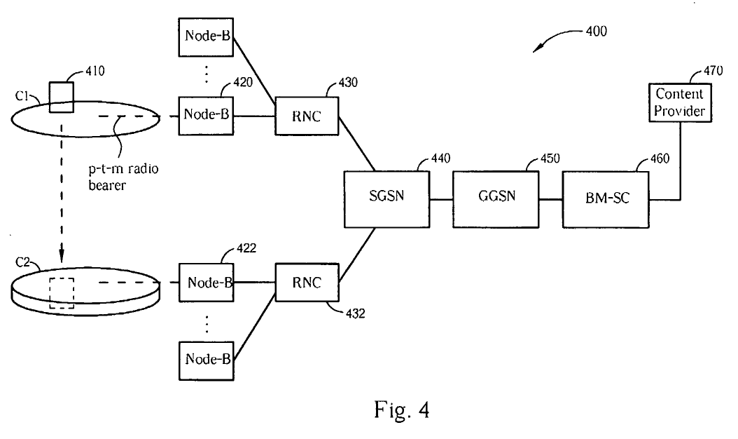

For example, please continue to refer to FIG. 4, which is a schematic diagram of a network framework 400 for handling a p-t-m MBMS service in the 3G mobile telecommunications system according to an embodiment of the present invention. The network framework 400 includes a User Equipment (UE) 410, Node-Bs (base stations) 420, 422, radio network controllers (RNCs) 430, 432, a Serving GPRS Support Node (SGSN) 440, a Gateway GPRS Support Node (GGSN) 450, a Broadcast Multicast Service Center (BM-SC) 460, and a Content provider 470. Preferably, the UE 410 is the receiving device 100. In FIG. 4, a p-t-m MBMS service is provided by the Node-B 420 for multiple UEs in a cell C1, and the Node-B 420 transmits configuration parameters of the radio bearer(s) used for receiving point-to-multipoint MBMS services. Contrarily, there is no p-t-m MBMS service provided in a cell C2.

After the Node-B 420 begins to provide the p-t-m MBMS service for the UE in the cell C1, as well as a mentioned Data Transfer session, the UE 410 operates the Layer 3 202 of the program code 112 via the control circuit 106 to receive radio bearer information through the MCCH, such as “MBMS COMMON P-T-M RB INFORMATION” and “MBMS CURRENT CELL P-T-M RB INFORMATION”. In addition, the layer 3 202 has to control the transceiver 114 via the Layer 1 218 for receiving electromagnetic waves carrying related configuration from Secondary Common Control Physical Channel (S-CCPCH) among the physical channels. In this situation, the UE 410 adjusts corresponding parameters of the control circuit 106, the transceiver 114, etc. by consistently receiving the p-t-m radio bearer information, so as to maintain quality of the p-t-m MBMS service.

When the UE 410 moves into the cell C2, the network framework 400 starts to process a routing procedure, the GGSN 450 transfers service data and corresponding information through the SGSN 440 for the RNC 432, and thereby the Node-B 422 transmits the service data and corresponding configuration to the UE 410. On the other hand, since the Node-B 422 does not provide p-t-m MBMS services for the UEs within the cell C2, the UE 410 cannot continue receiving the p-t-m MBMS service data and the corresponding configuration through MCCH. Thus, under this circumstance, the UE 410 of the present invention should stop all corresponding reception of the p-t-m MBMS service after moving into the Node-B 422 and determining that no p-t-m MBMS services are provided in the cell C2. That is, the UE 410 stops the control circuit 106 from executing reception of data from the p-t-m radio bearer(s). In other words, the UE 410 has to detect whether MCCH Configuration is included in System Information block type 5 or 5bis when moving into the new cell C2. If no MCCH Configuration is carried by the System Information block type 5 or 5 bis, the UE 410 releases the p-t-m radio bearer(s). On the contrary, the UE of the prior art may still operate the control circuit, the transceiver and the program code thereof to continue detection and reception of the p-t-m MBMS service even when the new cell C2 does not support p-t-m MBMS services, resulting in power consumption and resource waste in the UE.

Please note that, in the embodiment of the present invention, movement of the UE 410 from a cell into a new cell is an inter-RNC handover, which is only for explanation, and is not a limitation of the present invention. Thus, the movement of the UE can be an inter-SGSN or inter-Node-B handover.

In conclusion, according to the embodiment of the present invention, the receiving terminal should detect whether a cell supports p-t-m MBMS services when moving into a new cell, and thereby release the resource used for receiving the p-t-m MBMS service, preferably a radio bearer(s), after determining that the cell does not support p-t-m MBMS services. According to the prior art, the receiving terminal may not release the resource, and waste power and system resources, even shutting down. Therefore, compared with the prior art, the present invention can save power and system resources of the receiving terminal and protect software and hardware thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a point-to-multipoint Multimedia Broadcast Multicast Service (MBMS) service for a receiving terminal in a wireless communications system comprising:
detecting whether a cell provides the MBMS service when the receiving terminal moves into a new cell; and
releasing a resource used by the receiving terminal for receiving the MBMS service if the cell does not provide the MBMS service.

2. The method of claim 1, wherein the resource used by the receiving terminal for receiving the MBMS service is/are a radio bearer(s).

3. The method of claim 1, wherein the wireless communications system is a third generation mobile telecommunications system.

4. The method of claim 3, wherein detecting whether the cell provides the MBMS service is based on whether system information transmitted by the cell includes MBMS point-to-multipoint Control Channel (MCCH) configuration information.

5. The method of claim 4, wherein the system information transmitted by the cell is system Information block type 5 or 5bis.

6. A receiving device for correctly handling a point-to-multipoint Multimedia Broadcast Multicast Service (MBMS) service in a wireless communications system comprising:
a control circuit for realizing functions of the receiving device;
a processor installed inside the control circuit, for executing a program code to command the control circuit; and
a memory coupled to the processor, for storing the program code;
wherein the program code comprises:
detecting whether a cell provides the MBMS service when the receiving device moves into a new cell; and
releasing a resource used by the receiving device for receiving the MBMS service if the cell does not provide the MBMS service.

7. The receiving device of claim 6, wherein the resource used by the receiving device for receiving the MBMS service is/are a radio bearer(s).

8. The receiving device of claim 6, wherein the wireless communications system is a third generation mobile telecommunications system.

9. The receiving device of claim 8, wherein the program code further comprises detecting whether the cell provides the MBMS service according to whether system information transmitted by the cell includes MBMS point-to-multipoint Control Channel (MCCH) configuration information when the receiving device moves into the cell.

10. The method of claim 9, wherein the system information transmitted by the cell is system Information block type 5 or 5bis.
